(19) United States
(12) Patent Application Publication
(10) Pub. No.: US 2019/0044263 A1
(43) Pub. Date: Feb. 7, 2019

(54) CONNECTOR

(71) Applicant: KYOCERA Corporation, Kyoto-shi, Kyoto (JP)

(72) Inventors: Yosuke MANBA, Yokohama-shi, Kanagawa (JP); Nobuyuki NAKAJIMA, Taito-ku, Tokyo (JP)

(73) Assignee: KYOCERA Corporation, Kyoto-shi, Kyoto (JP)

(21) Appl. No.: 16/075,771

(22) PCT Filed: Feb. 8, 2017
(86) PCT No.: PCT/JP2017/004624

§ 371 Date: Aug. 6, 2018

(30) Foreign Application Priority Data
Feb. 9, 2016 (JP) 2016-022609

(51) Int. Cl. H01R 12/70; H01R 12/79

(52) U.S. Cl. CPC H01R 12/7058; H01R 12/79

(57) ABSTRACT

Provided is a connector capable of, when a closing operation of an actuator is mechanized, sufficiently applying rotational moment in a closing direction and preventing damage to the actuator. A connector (10) includes an insulator (30) into which a flat connection object is inserted, a contact group (40) that is supported by the insulator (30) and electrically connected to the connection object (20) inserted into the insulator (30), and an actuator (50) that is supported by the insulator (30) in an openable and closable manner, and also in a rotatable manner, and includes a connection object facing surface (52f) facing the flat connection object (20) in a closed state. The actuator (50) includes, on a surface opposite to the connection object facing surface (52f), a closing slope (52b) which reduces a distance to the connection object facing surface (52) as a distance from a rotation center of the actuator (50) increases.

### CROSS REFERENCE TO RELATED APPLICATION

This application claims priority to and the benefit of Japanese Patent Application No. 2016-022609 filed on Feb. 9, 2016, the entire contents of which are incorporated herein by reference.

### TECHNICAL FIELD

The present disclosure relates to a connector to be connected to a flat connection object such as an FPC (Flexible Printed Circuit) or an FFC (Flexible Flat Cable).

### BACKGROUND

A connector of the above type includes, as a basic structure, an insulator into which a connection object is inserted, a contact group supported by the insulator and electrically coupled to the connection object inserted into the insulator, and an actuator which is supported openably and closably, and also rotatably, by the insulator and includes an object pressing surface facing the connection object in a closed state and elastically pressing a terminal of the connection object against the contact group. The insulator includes an elastic pressing portion (a spring means) for acting on a rotation shaft of the actuator and thus pressing the actuator toward the connection object (PLT 1).

### CITATION LIST

### Patent Literature

PLT 1: JP-A-2002-124331

### SUMMARY

### Technical Problem

The connector electrically connects the connection object and the contact group together by closing the actuator in an open state with the connection object inserted into the insulator. Conventionally, a closing operation of the actuator is carried out by hand.

However, mechanization of the closing operation of the actuator is recently attempted. The mechanization of the closing operation can be carried out, in principle, by moving a closing jig relative to the actuator (the insulator) in the open state. However, conventional actuators, due to their shapes, cannot sufficiently provide rotational moment in a closing direction to the actuator during the movement of the closing jig relative to the actuator. Also, it was found that there is a risk that the actuator may be damaged such as buckling due to its difficulty in rotating in a closing direction.

As such, the present disclosure aims to provide a connector capable of sufficiently applying rotational moment in the closing direction to the actuator in the mechanized closing operation (to close the actuator by moving the closing jig relative to the actuator) and thus avoiding damage to the actuator.

### Solution to Problem

A connector includes: an insulator into which a flat connection object is inserted; a contact group supported by the insulator and electrically coupled to the connection object inserted into the insulator; and an actuator that is supported by the insulator in an openable and closable manner, and also in a rotatable manner, and includes a connection object facing surface facing the flat connection object in a closed state. The actuator includes, on a surface opposite to the connection object facing surface, a closing slope reducing a distance to the connection object facing surface as a distance from a rotation center of the actuator increases.

The closing slope may be formed in a portion of the actuator in an arranging direction of the contact group. The closing slope may be a flat surface.

In the connector according to a preferable embodiment of the present disclosure, a force application portion is located most distant from the rotation center of the closing slope and abuts a closing jig for applying a force in a closing direction to the actuator in an open state.

Preferably, the actuator and the insulator are each provided with an open position regulating portion for regulating an open position of the actuator in the open state.

A closing jig for applying a force in the closing direction to the actuator from above the actuator in a semi-closed state of the actuator between an open position and a closed position may abut the closing slope.

In the semi-closed state, a flat portion formed on a connection object contact portion of the actuator and a surface of the connection object are parallel to each other.

The actuator includes an opening slope that is formed contiguous to an edge of the connection object facing surface in a position distant from the rotation center and reduces a distance to the closing slope as a distance from the rotation center increases.

### Advantageous Effect

According to the present disclosure, on the surface of the actuator opposite to the connection object facing surface, the slope is formed to reduce a distance to the connection object facing surface as a distance from the rotation center of the actuator increases. Thus, in relative movement of the closing jig and the actuator, an abutment of the slope of the actuator in a free end portion of the actuator abuts the closing jig. According to the present disclosure, consequently, rotational moment in the closing direction may be sufficiently applied to the actuator, preventing damage to the actuator.

### BRIEF DESCRIPTION OF THE DRAWINGS

In the accompanying drawings:

FIG. 1 is a perspective view illustrating a separation state in which a connector according to an embodiment of the present disclosure is mounted on a substrate before a connection object is connected;

FIG. 2 is a perspective view illustrating the connector alone according to an embodiment of the present disclosure when the actuator is in a fully open state;

FIG. 3 is a perspective view illustrating the connector of FIG. 2 viewed from a rear direction;

FIG. 4 is a perspective view illustrating the connector of FIG. 2 when the actuator is in a fully closed state;

FIG. 5 is a perspective view illustrating a state in which a connection object is connected by the connector of FIG. 2 and the actuator is in the fully closed state;

FIG. 6 is a cross-sectional view taken from line VI-VI of FIG. 2;

FIG. 7 is a cross-sectional view taken from line VII-VII of FIG. 4;

FIGS. 8A, 8B, and 8C are cross-sectional views taken from a line similar to line IX-IX of FIG. 5, illustrating different steps to close the actuator from the fully open state of the actuator with the connection object inserted into the connector;

FIGS. 9A, 9B, and 9C are cross-sectional views taken from a line similar to line IX-IX of FIG. 5, illustrating different steps to close the actuator from a semi-closed state of the actuator with the connection object inserted into the connector to the fully closed state; and

FIGS. 10A and 10B are cross-sectional views illustrating steps, different from the steps of FIGS. 9B and 9C, to close the actuator from the semi-closed state of FIG. 9A to the fully closed state.

### DETAILED DESCRIPTION

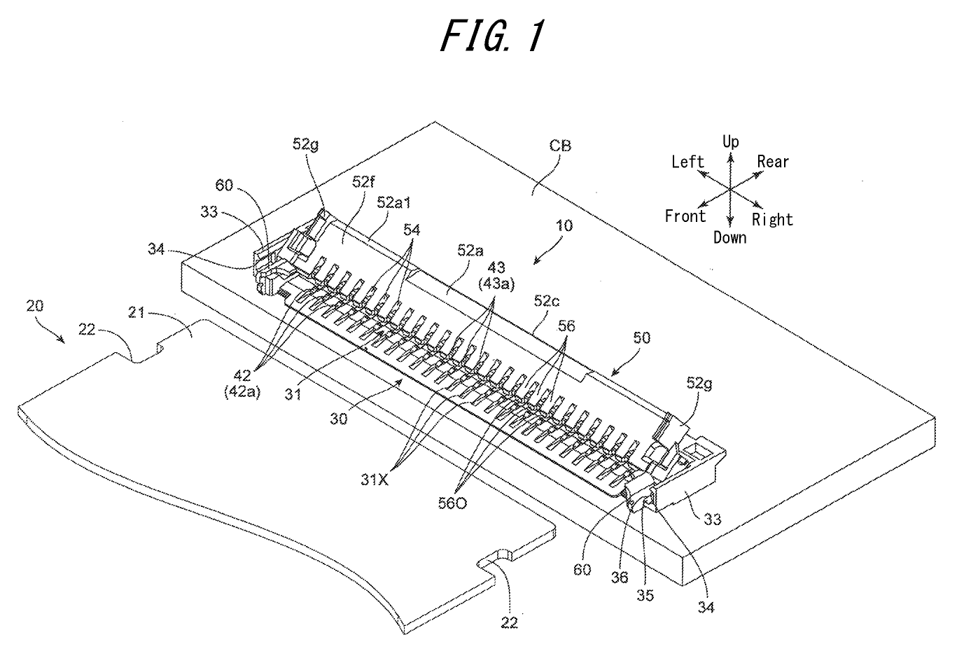

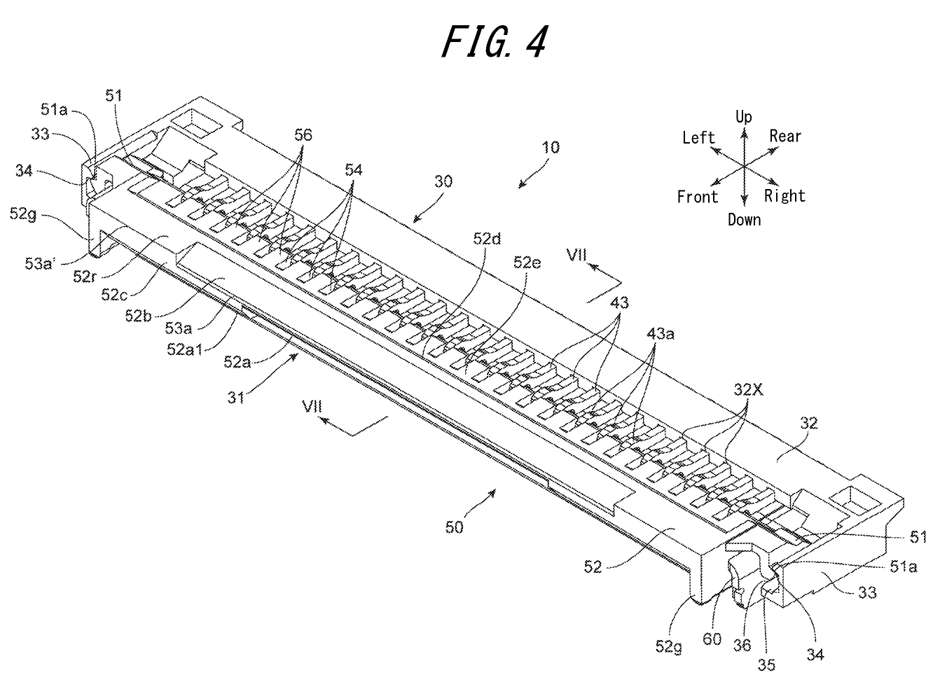

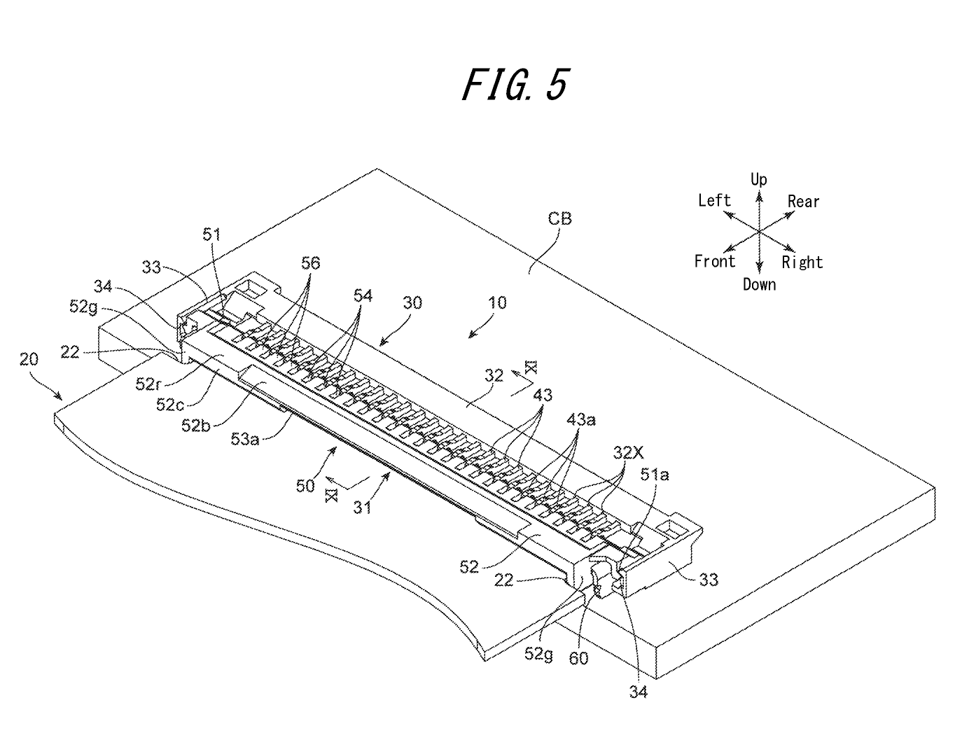

Referring to FIG. 1 to FIGS. 10A and 10B, a connector 10 according to an embodiment of the present disclosure will be described. The connector 10 is fixed on a circuit board CB. The connector 10 connects a circuit on the circuit board CB and a flat connection object 20 such as an FPC (Flexible Printed Circuit) or an FFC (Flexible Flat Cable) together. Hereinafter, directions (front, rear, up, down, left, and right) are based on the respective directions indicated by corresponding arrows illustrated in the figures. In the figures, a rear direction corresponds to an “insertion direction” of the connection object 20 into the connector 10. Also, a front direction corresponds to a “removal direction” of the connection object 20 from the connector 10. Further, a left-right direction corresponds to a “predetermined direction orthogonal to the removal direction” of the connection object 20 from the connector 10.

The connection object 20 is a sheet member (a film member) having a predetermined circuit (a wiring pattern, not illustrated) formed thereon. The connection object 20 includes left and right side surfaces each provided with an engaging recess 22 which is recessed inward and located off-center in the rear direction (a front side in the insertion direction). A rear portion of the connection object 20 from the engaging recesses 22 is referred to as a narrow portion 21, which in turn includes a bottom surface provided with a number of connection terminals (not illustrated) arranged at a constant pitch in the left-right direction (the predetermined direction) and electrically connected to the wiring pattern.

The connector 10 includes an insulator 30, a number of contacts 40 (a contact group) formed in the left-right direction on the insulator 30, an actuator 50 supported openably and closably (rotatably) by the insulator 30, and a pair of metal brackets 60 provided on either end in the left-right direction to fix the insulator 30 on the circuit board CB.

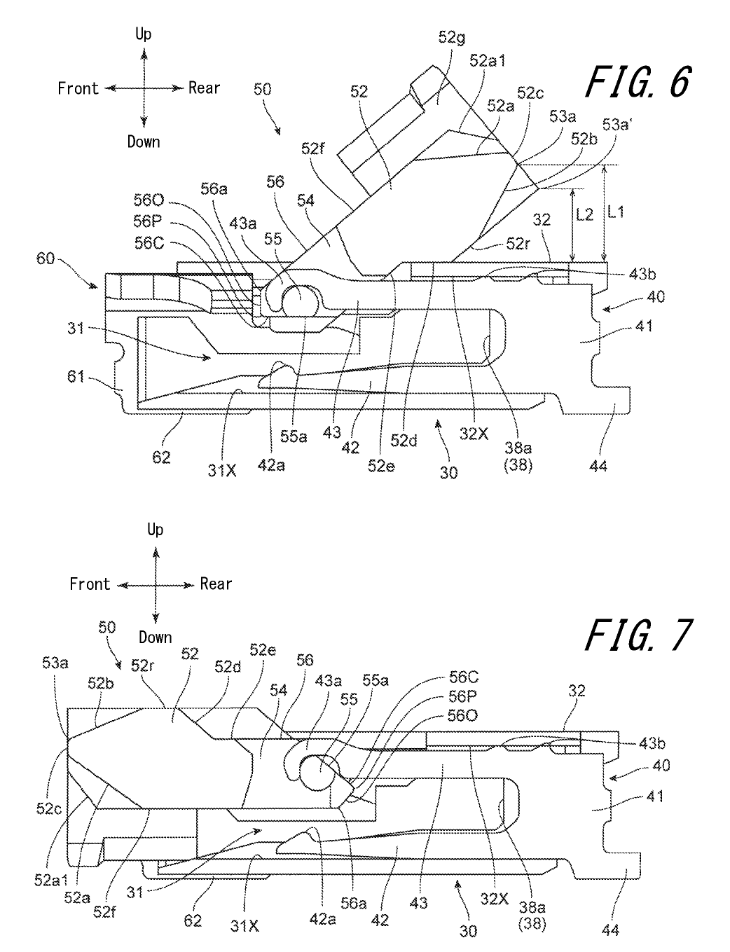

The insulator 30 is obtained by injection molding of a resin material (a synthetic resin material) having insulating and heat resistant properties. The insulator 30 includes a front top surface provided with an insertion portion 31 into which the connection object 20 is inserted from the front side. A left-right direction length (a width) of the insertion portion 31 corresponds to a left-right direction length of the narrow portion 21 of the connection object 20. The insulator 30 includes a roof portion 32 that is located on an upper rear side of the insertion portion 31 and protruding forward from a top end portion of a rear wall 38 of the insulator 30 (see FIG. 6 and FIG. 7).

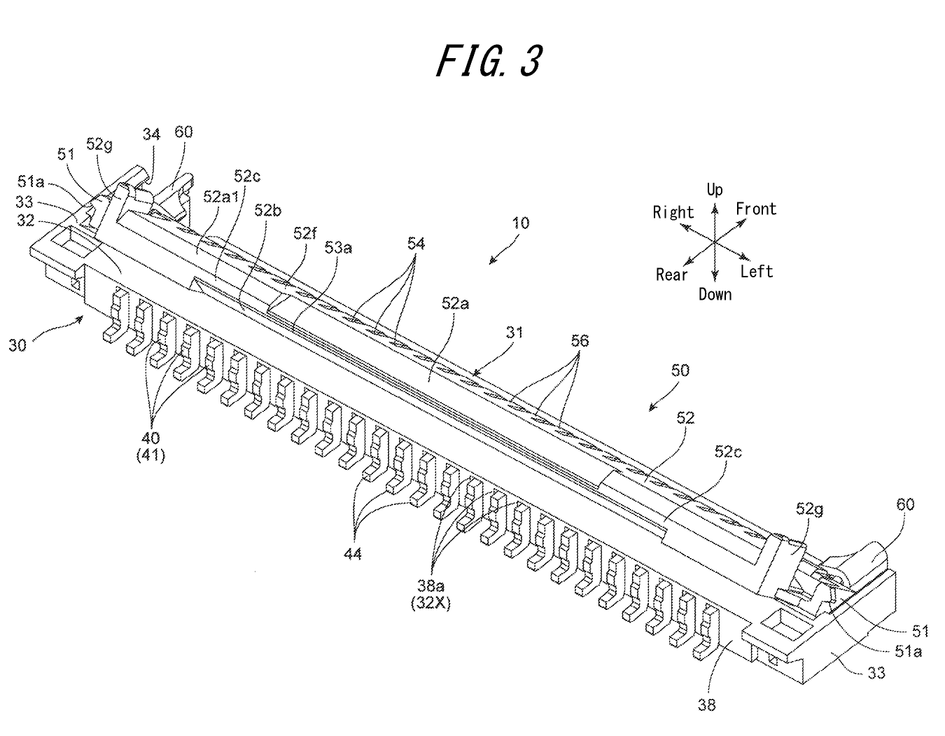

The insulator 30 includes a number of contact supporting grooves 31X formed in the insertion portion 31, a number of contact supporting grooves 32X formed in the roof portion 32, and communicating grooves 38a (see FIG. 3) for communicating contact supporting grooves 31X and contact supporting grooves 32X one another on the rear wall 38. The contact supporting grooves 31X, the contact supporting grooves 32X, and the communicating grooves 38a each extend in the front-rear direction and are arranged in the left-right direction (in the predetermined direction). A front portion of the contact supporting groove 31X is open to a front end portion of the insertion portion 31. A front portion of the contact supporting groove 32X is open to a front end portion of the roof portion 32.

The insulator 30 includes left and right end portions provided with a pair of side walls 33 located on the left and right sides of the insertion portion 31 and the roof portion 32. The pair of side walls 33 include front inner surfaces provided with a pair of engaging convex portions 34. The insulator 30 includes actuator supporting portions 35 on the left and right sides thereof. Between the actuator supporting portion 35 and the insertion portion 31, a pair of metal bracket supporting grooves 36 is formed. Press-fitting supporting portions 61 of the pair of metal brackets 60, obtained by press-molding of a metal plate, are pressed into, from under the insulator 30, and supported by the pair of metal bracket supporting grooves 36. A tail portion 62 of the metal bracket 60 (see FIG. 6 and FIG. 7) is soldered to (mounted on) the circuit board CB.

A contact 40 is obtained by molding a thin plate made of copper alloy (e.g., phosphor bronze, beryllium copper, titanium copper) or Corson copper alloy having a spring elasticity by using a progressive die (stamping) into the shape illustrated in the figures. A surface of the contact 40 is treated with nickel plating as an undercoat and then plated with gold.

As illustrated in FIG. 6 and FIG. 7, the contact 40 has a substantially U-shape in cross-section (a side face) including a base element 41, which in turn constitutes a rear portion of the contact 40 and extends in an up-down direction, a conductive arm 42 which is deformable in the up-down direction and extends forward from a bottom end portion of the base element 41, and a pressing arm (a stabilizer) 43 which is deformable in the up-down direction and extends forward from a top end portion of the base element 41. A front portion of the connection object 20 may be inserted into the space in the substantially U-shape. The front end portion of the conductive arm 42 includes a contact portion 42a extending obliquely upward. The upper surface of the contact portion 42a has a substantially chevron shape with a front slope gently sloping down forward from a crest in an R-shape and a rear slope rapidly descending in the rear direction. The contact portion 42a is electrically connected when the crest comes into contact with the connection terminal on the bottom surface of the connection object 20 inserted into the insertion portion 31.

The front end portion of the pressing arm 43 includes a rotation shaft supporting portion (an elastic pressing portion) 43a having a substantially semi-circular arc shape which opens downward. The pressing arm 43, in its portion close to the base element 41, includes two engaging projections 43b projecting upward at positions separate from each other in the front-rear direction. The bottom end of the base element 41 includes, opposite to the conductive arms 42, a tail portion 44 which extends downward and projects rearward.

The contact 40 is inserted into, from the rear side of the insulator 30 via the insulator groove 38a, and supported by the contact supporting groove 31X and the contact supporting groove 32X. In this state, the conductive arm 42 is supported along the contact supporting groove 31X of the insertion portion 31 and prevented from shifting in the left-right direction. Also, the pressing arm 43 is supported along the contact supporting groove 32X of the roof portion 32 and prevented from shifting in the left-right direction. In this state, both of the engaging projections 43b formed on the pressing arm 43 are fitted in the contact supporting groove 32X of the roof portion 32. Thus, the contacts 40 is locked and restrained from shifting in the front-rear direction. The contact portion 42a of the conductive arm 42 protrudes upward from the contact supporting groove 31X of the insertion portion 31. A rotation shaft supporting portion 43a of the pressing arm 43 protrudes forward from the contact supporting groove 32X of the roof portion 32. Also, the tail portion 44 is soldered to (mounted on) the circuit board CB.

The actuator 50 is obtained by injection molding of a resin material (a synthetic resin material) having insulating and heat resistant properties. The actuator 50 is formed from a plate-like member extending in the left-right direction. The actuator 50 includes a pressing plate portion 52 having a plate-like shape. At left and right end portions of the pressing plate portion 52, a pair of supported portions 51 is formed and supported by the pair of actuator supporting portions 35 of the insulator 30. Each of the supported portions 51 includes an engaging convex portion 51a for engaging with the engaging convex portion 34 of the insulator 30 when the actuator 50 rotates to a fully closed position and locking the actuator 50 in the fully closed state.

The actuator 50 includes, at a rear end thereof, a number of pressing arm insertion grooves (stabilizer insertion grooves) 54 which penetrate the actuator 50 in a plate-thickness direction and are arranged at predetermined intervals in the left-right direction (the predetermined direction). An interpolar wall 56 is formed between the pressing arm insertion grooves 54 adjacent to each other. Inside a number of pressing arm insertion grooves 54 (between the interpolar walls 56 adjacent to each other), engaging and rotation shafts 55 concentric to each other are formed in the left-right direction (the predetermined direction). When the pressing arm 43 of the contact 40 is inserted into each of the pressing arm insertion grooves 54 and, also, each of the rotation shaft supporting portions 43a of the contact 40 is fixedly engaged with each of the engaging and rotation shaft 55, the actuator 50 is supported by the insulator 30 rotatably (openably and closably) about the engaging and rotation shaft 55.

As illustrated in FIG. 6 and FIG. 7, an end portion of each of the interpolar walls 56 close to the engaging and rotation shaft 55 is provided with a semi-closing surface (a flat portion) 56O, a closing surface 56C, and a front end pressing portion 56P having a round shape located at an intersection of the semi-closing surface 56O and the closing surface 56C. The engaging and rotation shaft 55 includes a D-cut surface 55a forming the same surface together with the closing surface 56C. The closing surface 56C and the D-cut surface 55a, in the fully open state of the actuator 50, are parallel to the flat connection object 20 inserted into the insertion portion 31. At an intersection of the semi-closing surface 56O and the connection object facing surface 52f, a force application portion 56a is formed, and the top surface of the connection object 20 abuts the force application portion 56a in the course of the rotation of the actuator 50 to the fully closed state.

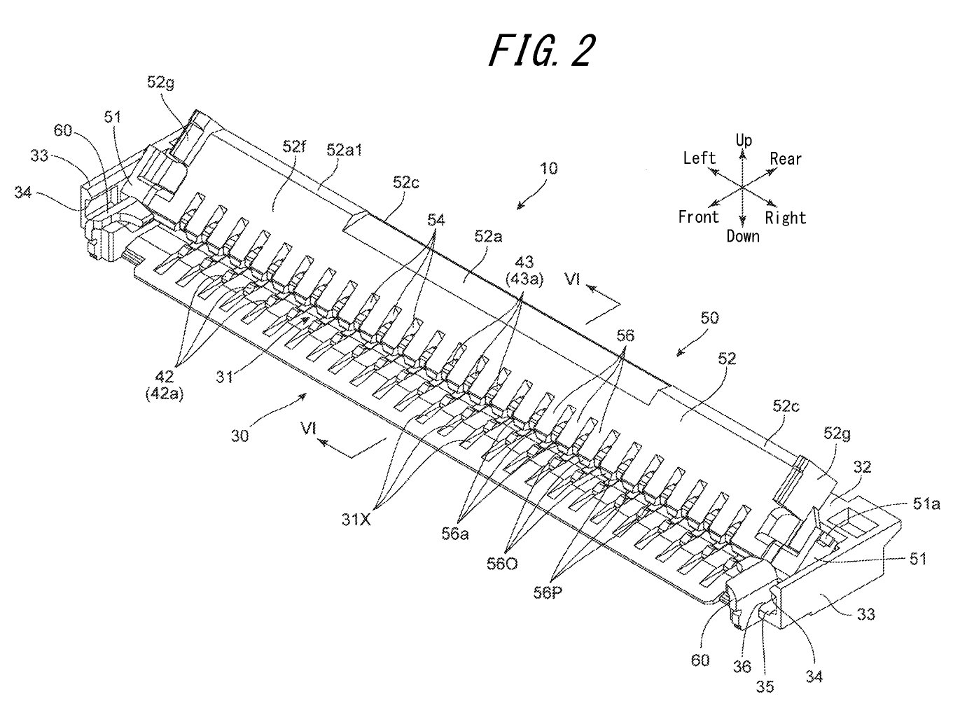

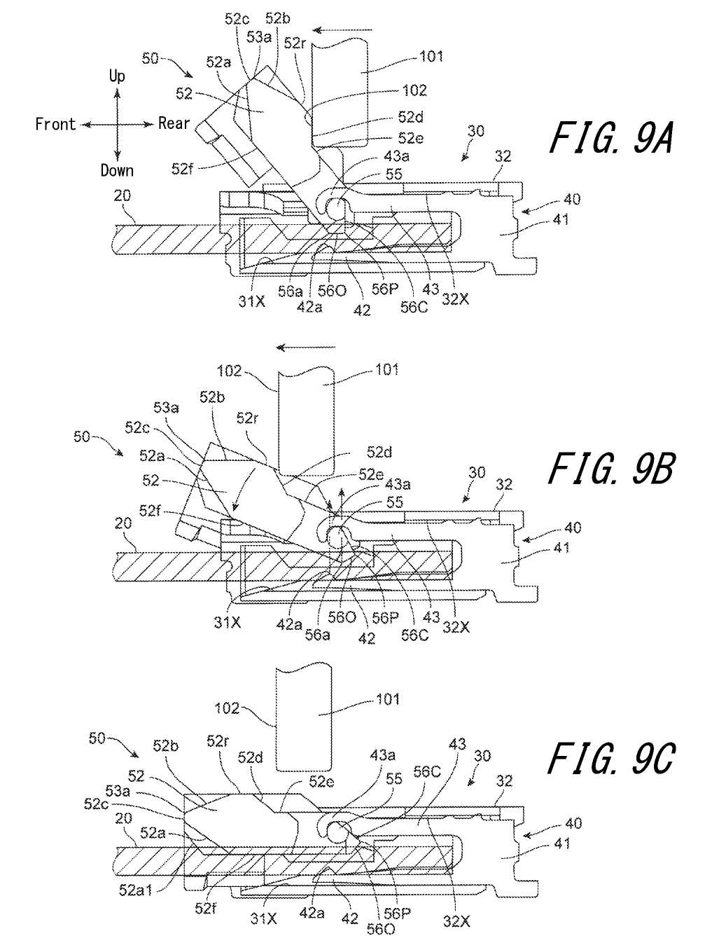

The pressing plate portion 52 includes a facing surface (an inner surface) 52f facing the connection object 20 when the actuator 50 is in the fully closed state, and an outer surface 52r located outside (on the rear side) (see FIGS. 2, 4, 6, 7, etc.). The connection object facing surface 52f forms, when the actuator 50 is in the fully closed state, a pressing surface for contacting the top surface of the connection object 20 and elastically pressing the connection terminal on the bottom surface of the connection object 20 against the contact 40 (the contact portion 42a) (see FIG. 7 and FIG. 9A). The connection object facing surface 52f includes an opening slope 52a which reduces a distance to the outer surface 52r as a distance from the rotation center (the engaging and rotation shaft 55) of the actuator 50 increases. A central portion in the longitudinal direction of the opening slope 52a includes a great opening slope 52a1 having a greater inclination.

The outer surface 52r of the actuator 50 includes, in the central portion of the actuator 50 in the left-right (width) direction, a closing slope 52b which reduces a distance to the connection object facing surface 52f as a distance from the rotation center (the engaging and rotation shaft 55) increases (toward a free end portion). An end surface in the free end portion includes a free end flat surface 52c for connecting the connection object facing surface 52f, the outer surface 52r, the opening slope 52a, and the closing slope 52b. An intersection of the closing slope 52b and the free end flat surface 52c includes a force application portion 53a.

The outer surface 52r includes, close to the rotation center (the engaging and rotation shaft 55) from the closing slope 52b, an open position regulating surface 52d which reduces a distance to the connection object facing surface 52f as reducing a distance to the rotation center. A flat surface 52e parallel to the outer surface 52r is formed contiguously to the open position regulating surface 52d. The pressing arm insertion grooves 54 are each open to the flat surface 52e. A rear surface of the interpolar wall 56 is formed by the flat surface 52e (see FIG. 7).

The pressing plate portion 52 includes, on each of the left and right end portions thereof in the free end portion, a connection object engaging protrusion 52g extending forward from the connection object facing surface 52f. When the actuator 50 is in the fully closed state, the connection object engaging protrusions 52g on both the left and right sides engage with engaging recesses 22 on the left and right sides of the connection object 20 and thus retain the connection object 20.

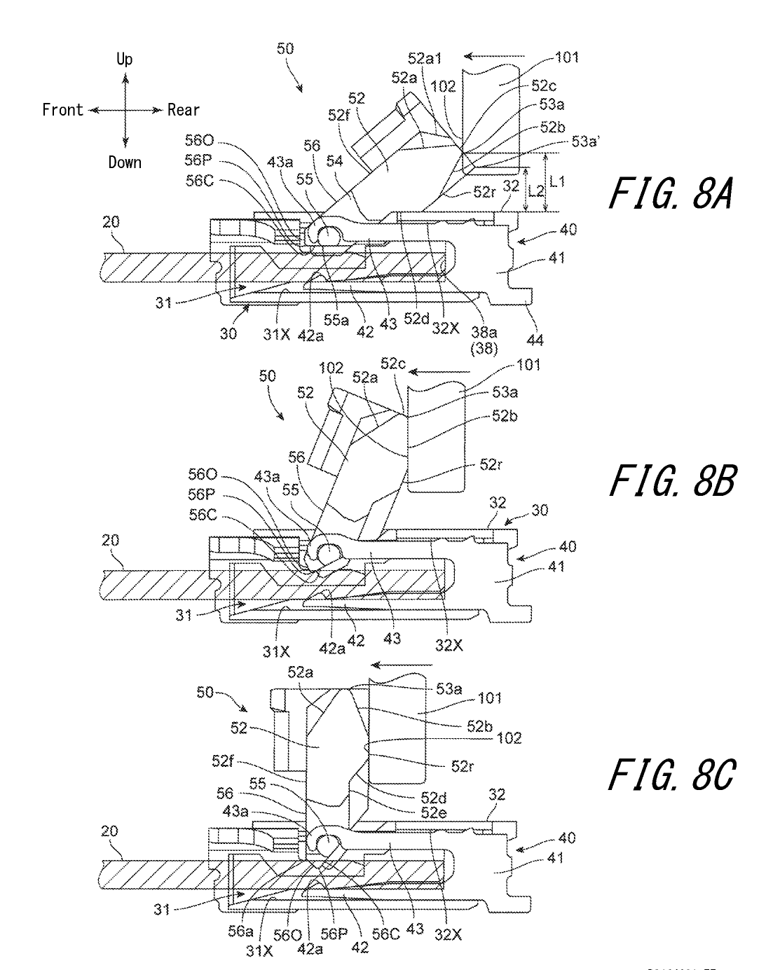

Next, referring to FIGS. 8A to 8C, FIGS. 9A to 9C, and FIGS. 10A and 10B, operation to connect the connection object 20 to the connector 10 will be described in detail.

In the fully open state of the actuator 50 illustrated in FIG. 8A and FIG. 6, the open position regulating surface 52d of the actuator 50 abuts the top surface of the roof portion 32 of the insulator 30. According to the present embodiment, an opening angle of the actuator 50 in the fully open state exceeds 90 degrees (e.g., approximately 120 degrees, measured in the clockwise direction from the front direction, set as 0 degrees in the figures, to the rear direction). In the fully open state, the open position regulating surface 52d is in surface contact with the top surface of the roof portion 32 of the insulator 30. Accordingly, even if a clockwise force or a force applied from above the actuator 50 is applied to the actuator 50, the actuator 50 may be reliably retained in the fully open state. In the fully open state of the actuator 50, the closing surface 56C in the top end portion of the interpolar wall 56 of the actuator 50 and the D-cut surface 55a of the engaging and rotation shaft 55 are parallel with the connection object 20 inserted into the insertion portion 31. Thus, the connection object 20 may be inserted into the insertion portion 31 of the insulator 30 by ZIF (Zero Insertion Force). In this state, the conductive arm 42 of the contact 40 is in a free state without elastic deformation. The bottom surface of the connection object 20 is supported by (rests on) a top end surface of the contact portion 42a.

The connection object 20 is inserted into the insertion portion 31 of the insulator 30 until reaching a normal position (until the rear end contacts the rear wall 38). Then, the closing jig 101 for closing the actuator 50 applies, via the pressing plate portion 52, a rotation force to rotate the actuator 50 in a counterclockwise direction in the figure. Thus, the actuator 50 is closed. The closing jig 101 has a prism shape with a front pressing surface 102 in contact with the force application portion 53a of the actuator 50 and a bottom pressing surface 103 serving as a bottom surface. A left-right direction length of the front pressing surface 102 is shorter than a left-right length of the closing slope 52b. The closing jig 101 is supported by a driving apparatus such as an air cylinder apparatus capable of shifting in the front-rear direction and performing an elevation movement (in the up-down direction).

In other words, the actuator 50 may open to a position where the force application portion 53a of the closing slope 52b abuts the closing jig 101 for moving laterally.

The closing jig 101 linearly moves approaching the pressing plate portion 52 in a direction parallel to the front-rear direction of the pressing plate portion 52 from behind the pressing plate portion 52. In this state, the front pressing surface 102 abuts the force application portion 53a (see FIG. 8A). A distance L1 represents a distance between the position where the front pressing surface 102 abuts the force application portion 53a and the top surface of the roof portion 32 (see FIG. 6 and FIG. 8A). If the closing slope 52b is not provided (i.e., in a conventional actuator), the front pressing surface 102 of the closing jig 101 abuts a force application portion 53a′ (see FIG. 6 and FIG. 8A) at an intersection of the outer surface 52r and the free end flat surface 52c. In this case, a distance L2 represents a distance between a position where the front pressing surface 102 abuts the force application portion 53a′ and the top surface of the roof portion 32. Thus,

L1>L2

is satisfied. That is, in the fully open state of the actuator 50, initial rotational torque for rotating the actuator 50 in a fully closing (a closing) direction by using the closing jig 101 with the same pressing force is greater when the front pressing surface 102 of the closing jig 101 abuts the force application portion 53a of the closing slope 52b, rather than when the closing jig 101 abuts the force application portion 53a′ of the outer surface 52r and the free end flat surface 52c. According to the present embodiment, thus, when a small forward-moving force is applied to the closing jig 101, the actuator 50 in the fully open position may be rotated in the closing direction with a great rotational torque.

The connector 10 according to the present embodiment may increase the distance L1. This increases the clearance between the top surface (the roof portion 32) of the connector 10 (the insulator 30) and the closing jig 101. This eliminates the risk that the closing jig 101 collides with the connector 10, thus providing excellent workability. Even if there is a component which costs more than the connector 10 in the vicinity of the connector 10, there is a less risk for the closing jig 101 to contact the component, thus providing excellent workability. Preferably, the open position regulating surface 52d of the actuator 50 is set so that the distance L1 is as long as possible relative to the top surface of the roof portion 32.

FIG. 8B illustrates a state in which the actuator 50 in the fully open state is slightly rotated in the closing direction by moving the closing jig 101 forward. The front pressing surface 102 of the closing jig 101 is rotated in the closing direction of the actuator 50 while sliding on the force application portion 53a. The front pressing surface 102 is moved to a position in contact with the closing slope 52b in its entirety. When the actuator 50 rotates in this manner, the top end pressing portion 56P of the interpolar wall 56 contacts the top surface of the connection object 20 and presses the connection object 20 downward. Simultaneously, the top end pressing portion 56P pushes the connection object 20 rearward while sliding thereon and sits on the top surface of the connection object 20. Thus, the engaging and rotation shaft 55 of the actuator 50 and the rotation shaft supporting portion 43a of the contact 40 which supports the engaging and rotation shaft 55 are lifted slightly upward by elastic deformation of the pressing arm 43 in the upward direction. On the other hand, the connection object 20 being pressed by the top end pressing portion 56P and the contact portion 42a in contact with the connection terminal on the bottom surface of the connection object 20 are pressed slightly downward due to the elastic deformation of the conductive arm 42 in the downward direction. Note that FIGS. 8A to 8C, FIGS. 9A to 9C, and FIGS. 10A and 10B illustrate a free state in which the conductive arm 42 and the pressing arm 43 are not elastically deformed.

FIG. 8C illustrates a state in which the opening angle of the actuator 50 is approximately 90 degrees. In this state with the closing jig 101 moved further forward from the position illustrated in FIG. 8B, an abutting position of the front pressing surface 102 of the closing jig 101 in respect of the actuator 50 shifts from the force application portion 53a to the outer surface 52r. At this time, the top end pressing portion 56P of the interpolar wall 56 presses the connection object 20 downward.

FIG. 9A illustrates the semi-closed state in which the actuator 50 is further rotated in the closing direction from the open state illustrated in FIG. 8C such that the semi-closing surface 56O of the interpolar wall 56 has parallel contact (surface contact) with the top surface of the connection object 20. According to the present embodiment, the open angle of the actuator 50 is approximately 60 degrees in this state. Also, an elastic force in a direction passing through the rotation shaft of the actuator 50 from the semi-closing surface 56O (a center in the front-rear direction thereof) is acting on the actuator 50. Thus, the rotational moment does not act on the actuator 50. In this way, the actuator 50 is retained in the semi-closed state (a so-called click-stop state). The semi-closed state is maintained when a biasing force by the closing jig 101 is released.

FIG. 9B illustrates a state in which the closing jig 101 is further moved forward such that the actuator 50 is further rotated in the closing direction from the semi-closed state illustrated in FIG. 9A and has the open angle smaller than 45 degrees. The connection object 20 is pressed upward by the conductive arm 42 via the contact portion 42a. The top surface of the connection object 20 presses the force application portion 56a of the actuator 50 in the upward direction (as indicated by the arrow in FIG. 9B). When the actuator 50 is rotated in the closing direction in this state and a pressing portion of the force application portion 56a by the connection object 20 moves rearward from the rotation center of the actuator 50 (i.e., passes a reverse position in the closing direction), rotational moment acting on the force application portion 56a is inverted in the closing direction from the opening direction. This causes the rotational moment (rotational torque) in the closing direction to act on the actuator 50 and rotates the actuator 50 in the closing direction (in the direction indicated by the arrow in FIG. 9B).

FIG. 9C illustrates a state in which the actuator 50 is rotated to the closed position by the biasing force of the conductive arms 42. In the closed state, the connection object facing surface 52f of the actuator 50 abuts the top surface of the connection object 20. Due to an elastic biasing force acting in a direction to bring the conductive arm 42 and the pressing arm 43 close to each other, a contact state of the contact portion 42a and the connection terminal on the bottom surface of the connection object 20 is maintained. Further, the engaging convex portion 51a engages with the engaging convex portion 34 of the insulator 30, and thus the actuator 50 is locked in the fully closed state. In the fully closed state, when the closing jig 101 is raised and separated from the actuator 50, the actuator 50 maintains the fully closed state. Also, the connection object engaging projections 52g on the left and right sides of the actuator 50 engage with the engaging recesses 22 of the connection object 20, and thus the connection object 20 is prevented from being removed from the insertion portion 31.

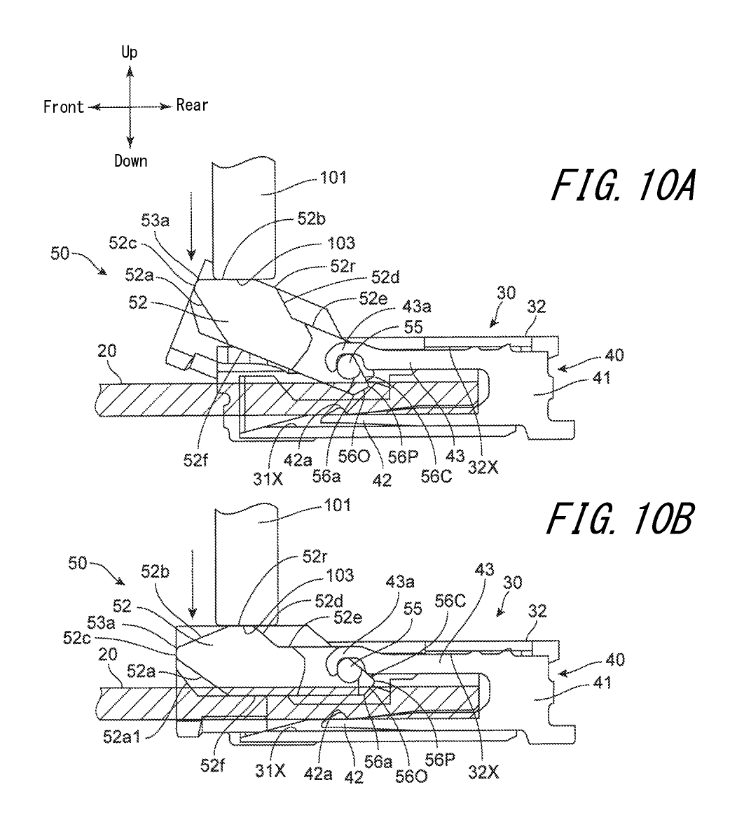

In the above embodiment, the forward moving force of the closing jig 202 rotates the actuator 50 in the fully open state in the closing direction passing the semi-closed state, and the actuator 50 is rotated to the fully closed state by the rotational torque in the closing direction by the elastic bias of the contact 40 (the conductive arm 42 and the pressing arm 43). However, the actuator 50 can also be rotated to the fully closed state by the moving force of the closing jig 101 acting in the front and downward directions. FIGS. 10A and 10B illustrate an embodiment in which, after the actuator 50 is rotated to the semi-closed state, the closing jig 101 is shifted upward, forward, and then downward such that the actuator 50 is rotated to the fully closed state.

FIG. 10A illustrates a state in which the actuator 50 is closed with the opening angle of approximately 30 degrees by the forward movement of the closing jig 101. Here, the closing jig 101 is moved upward from the half-closed state (the click-stop state) illustrated in FIG. 9A, such that the front pressing surface 102 separates from the open position regulating surface 52d. Subsequently, the closing jig 101 is moved forward and then downward, such that the bottom pressing surface 103 of the closing jig 101 abuts the closing slope 52b of the actuator 50. The closing jig 101 is moved further downward such that the actuator 50 is rotated counterclockwise (in the closing direction) (see FIG. 10B). Then, the force application portion 56a of the semi-closing surface 56O of the interpolar wall 56 and the connection object facing surface 52f abuts the top surface of the connection object 20, further pressing down the connection object 20.

FIG. 10B illustrates the actuator 50 in the fully closed state. The actuator 50 may be rotated to the fully closed state by the rotational torque in the closing direction by the elastic bias of the contact 40 (the conductive arm 42 and the pressing arm 43). According to the present embodiment, the closing jig 101 is moved downward to reliably rotate the actuator 50 to the fully closed state.

The above embodiment is characteristic in performing the closing operation of the actuator 50 in two stages; moving the closing jig 101 in the lateral direction (in a direction parallel to the circuit board CB) and moving the closing jig 101 in the longitudinal direction (in the direction orthogonal to the circuit board CB). The closing slope 52b (or the force application portion 53a) of the actuator 50 functions as a surface for enabling this two-stage movement.

In the connector 10 according to the present embodiment, the pressing plate portion 52 of the actuator 50 includes the connection object facing surface 52f located on a front side in the fully open state and the outer surface 52r located opposite to the connection object facing surface 52f. In the connector 10 according to the present embodiment, the outer surface 52r includes the closing slope 52b which reduces a distance to the connection object facing surface 52f as a distance from the rotation center (the engaging and rotation shaft 55) of the actuator 50 increases. Thus, in the fully open state of the actuator 50, when the closing jig 101 is brought to abut the actuator 50 from behind, the front pressing surface 102 of the closing jig 101 abuts the pressure application portion 53a distant from the rotation center (the engaging and rotation shaft 55) of the actuator 50. Accordingly, a great rotational torque in the closing direction may be applied to the actuator 50. That is, the closing operation of the actuator 50 may be readily mechanized.

In the connector 10 according to the present embodiment, further, in the course of the movement of the actuator 50 from the fully open state to the fully closed state, the semi-closing surface 56O contacts the top surface of the connection object 20 and thus retains the actuator 50 in the semi-closed state (the click-stop state). Accordingly, when the jig 101 for moving forward is moved away from the actuator 50, moved above and toward the front side of the actuator 50, and then moved downward, the actuator 50 may be reliably rotated to the fully closed state. Note that the closing jig 101 for moving in the front-rear direction and a closing jig for moving in the up-down direction may be separately provided.

According to the present embodiment, the connection object facing surface 52f of the actuator 50 in its entirety serves as a pressing surface for elastically pressing the connection terminal on the bottom surface of the connection object 20 against the contact 40 (the contact portion 42a). However, the connection object facing surface 52f may include a portion with a small projection for increasing the pressure in conjunction with the contact portion 42a of the contact 40.

The above embodiment has been described by using an example in which all of the plurality of interpolar walls 56 are provided with the semi-closing surface 56O, the closing surface 56C, and the top end pressing portion 56P. However, only some of the plurality of interpolar walls 56 may be provided with the semi-closing surface 56O, the closing surface 56C, and the top end pressing portion 56P. For example, every second, every third, or every forth of the interpolar wall 56, or a combination thereof may be provided with the semi-closing surface 56O, the closing surface 56C, and the top end pressing portion 56P. This enables, even when the contact 40 is multipolar, a reduction in an operating force of the actuator 50. Alternatively, some of the plurality of interpolar walls 56 may be omitted.

In the above embodiment, the closing slope 52b is a flat surface. However, the closing slope 52b may be a curved surface such as an outwardly convex surface. The closing slope 52b may be a curved surface contiguous to the outer surface 52r.

Further, although in the above embodiment one closing slope 52b (the force application portion 53a) is formed in the central portion (a portion) of the width direction of the actuator 50, a plurality of closing slopes 52b (force application portions 53a) may be provided at intervals. In this case, the plurality of closing slopes 52b (force application portions 53a) may each be configured to engage with the closing jig.

### REFERENCE SIGNS LIST

10 connector

20 connection object

21 narrow portion

22 engaging recess (locking recess)

30 insulator

31 insertion portion

31X contact supporting groove

32 roof portion

32X contact supporting groove

33 side wall

34 engaging convex portion

35 actuator supporting portion

36 metal bracket supporting groove

40 contact (contact group)

41 base element

42 conductive arm

42a contact portion

43 pressing arm (stabilizer)

43a rotation shaft supporting portion (elastic pressing portion)

43b engaging projection

44 tail portion

50 actuator

51 supported portion

51a engaging convex portion

52 pressing plate portion

52a opening slope

52b closing slope

52c free end flat surface

52d open position regulating surface (open position regulating portion)

52e flat surface

52g connection object engaging projection (rocking projection)

52f connection object facing surface (connection object pressing surface)

52r outer surface

53a force application portion

54 pressing arm insertion groove (stabilizer insertion groove)

55 engaging and rotation shaft

56 interpolar wall (connection object contact portion)

56O semi-closing surface (flat portion)

56C closing surface

56P top end pressing portion

60 metal bracket

61 press-fitting supporting portion

101 closing jig

102 front pressing surface

103 bottom pressing surface

1. A connector comprising:
an insulator into which a flat connection object is inserted;
a contact group supported by said insulator and electrically connected to said connection object inserted into said insulator; and
an actuator supported by said insulator in an openable and closable manner, and also in a rotatable manner, and including a connection object facing surface for facing said flat connection object in a closed state,
wherein said actuator includes, on a surface opposite to said connection object facing surface, a closing slope reducing a distance to said connection object facing surface as a distance from a rotation center of said actuator increases.

2. The connector according to claim 1,
wherein said closing slope is formed in a portion of said actuator in an arranging direction of said contact group.

3. The connector according to claim 1,
wherein said closing slope is a flat surface.

4. The connector according to claim 1,
wherein a force application portion is located most distant from said rotation center of said closing slope and abuts a closing jig for applying a force in a closing direction to said actuator in an open state.

5. The connector according to claim 3,
wherein said actuator and said insulator each include an open position regulating portion for regulating an open position of said actuator in an open state.

6. The connector according to claim 1,
wherein a closing jig for applying a force in a closing direction to said actuator from above said actuator in a semi-closed state of said actuator between an open position and a closed position abuts said closing slope.

7. The connector according to claim 5,
wherein, in said semi-closed state, a flat portion formed on a connection object contact portion of said actuator and a surface of said connection object are parallel to each other.

8. The connector according to claim 1,
wherein an opening slope is formed contiguous to an edge of said connection object facing surface of said actuator in a position distant from said rotation center and reduces a distance to said closing slope as a distance from said rotation center increases.
